(19) United States
(12) Patent Application Publication
(10) Pub. No.: US 2026/0185020 A1
(43) Pub. Date: Jul. 2, 2026

(54) CLEANING SOLUTION FOR INKJET HEAD, METHOD FOR CLEANING INKJET HEAD USING THE SAME, AND ELECTRONIC DEVICE MANUFACTURED USING THE METHOD

(71) Applicant: Samsung Display Co., Ltd., Yongin-si (KR)

(72) Inventors: KEUNSOO LEE, Yongin-si (KR); KATSUYUKI HIRATO, Yongin-si (KR); WONJOON CHOI, Yongin-si (KR); KONTA YU, Yongin-si (KR); TOMOEDA SATOSHI, Yongin-si (KR); MYUNGSOO HUH, Yongin-si (KR)

(21) Appl. No.: 19/296,758

(22) Filed: Aug. 11, 2025

(30) Foreign Application Priority Data
Jan. 2, 2025 (KR) 10-2025-0000383

(51) Int. Cl. C11D 3/43; B41J 2/165; C11D 3/00; C11D 3/20

(52) U.S. Cl. CPC C11D 3/43; B41J 2/16552; C11D 3/0084; C11D 3/2093; B41J 2002/16567; C11D 2111/22; C11D 2111/44

(57) ABSTRACT

A cleaning solution for an inkjet printer head, the cleaning solution having a non-affinity to an epoxy resin greater than a non-affinity to a photocurable solute, a cleaning method for an inkjet printer head using the cleaning solution, and an electronic device manufactured using the cleaning solution.

### CROSS-REFERENCE TO RELATED APPLICATION

The present application claims priority to and the benefit of Korean Patent Application No. 10-2025-0000383, filed on Jan. 2, 2025, in the Korean Intellectual Property Office, the entire content of which is incorporated herein by reference.

### BACKGROUND

### 1. Field

Embodiments of the present disclosure relate to a cleaning solution for an inkjet printer head, a cleaning method for an inkjet printer head using the cleaning solution, and an electronic device manufactured using the cleaning method.

### 2. Description of the Related Art

Ink may be used in the manufacture of a display device, such as Liquid Crystal Displays (LCDs) and/or organic Electroluminescent (EL) devices. An inkjet printer head may be used to eject ink onto a substrate for printing.

However, during printing with an inkjet printer head, even if the nozzle unit is frequently washed using a wiper, repetitive use may cause contamination of the printer head or nozzle with ink residues. This contamination may lead to non-ejection or mis-deposition of the ink. Therefore, it may be necessary or desirable to efficiently clean the inside of an inkjet printer head and nozzle unit to increase the lifespan of the inkjet printer head, to reduce costs associated with replacing expensive printer heads, and to minimize or reduce the time spent on cleaning.

The information disclosed in this Background section is intended to enhance understanding of the background of the disclosure and may contain information that does not constitute prior art.

### SUMMARY

Aspects according to one or more embodiments of the present disclosure are directed toward a cleaning solution for an inkjet printer head, a cleaning method for an inkjet printer head using the solution, and an electronic device manufactured using the cleaning method.

Additional aspects will be set forth in part in the description which follows and, in part, will be apparent from the description, or may be learned by practice of the presented embodiments of the disclosure.

Objects/aspects of the present disclosure are not limited to the one or more embodiments described herein, and other undescribed technical objects/aspects shall be clearly understood by a person ordinarily skilled in the art from the following descriptions.

According to one or more embodiments, a cleaning solution for an inkjet printer head may include: a solvent; and a photocurable solute, wherein the solvent has a non-affinity to an epoxy resin greater than a non-affinity to the photocurable solute.

In one or more embodiments, the solvent has Hansen parameters of the epoxy resin and the photocurable solute that may satisfy the conditions of Equation 1.

$$\sqrt{{( δ {p}_{1} - δ {p}_{2} )}^{2} + {( δ {h}_{1} - δ {h}_{2} )}^{2}} > \sqrt{{( δ {p}_{1} - δ {p}_{3} )}^{2} + {( δ {h}_{1} - δ {h}_{3} )}^{2}} \qquad Equation 1$$

In the Equation 1, δp₁ is a polar-dipolar energy parameter of a solvent,
δh₁ is a hydrogen bond energy parameter of the solvent,
δp₂ is a polar-dipolar energy parameter of an epoxy resin,
δh₂ is a hydrogen bond energy parameter of the epoxy resin,
δp₃ is a polar-dipolar energy parameter of a photocurable solute, and ohs is a hydrogen bond energy parameter of the photocurable solute.

In one or more embodiments, the polar-dipolar energy parameter δp₁ among the Hansen parameters of the solvent may be greater than or equal to 1 and less than or equal to 7.

In one or more embodiments, the hydrogen bond energy parameter δh₁ among the Hansen parameters of the solvent may be greater than or equal to 3.5 and less than or equal to 15.

In one or more embodiments, the solvent may have a non-affinity to the photocurable solute greater than or equal to 1.0 and less than or equal to 7.5.

In one or more embodiments, the solvent may have a non-affinity to the epoxy resin greater than or equal to 5.0 and less than or equal to 10.5.

In one or more embodiments, the solvent may include one or more selected from among dipropylene glycol n-propyl ether, dipropylene glycol n-butyl ether, propylene glycol n-butyl ether, propylene glycol n-propyl ether, tripropylene glycol n-butyl ether, propylene glycol phenyl ether, dipropylene glycol phenyl ether, dipropylene glycol dimethyl ether, propylene glycol methyl ether acetate, dipropylene glycol methyl ether, dipropylene glycol methyl ether acetate, tripropylene glycol methyl ether, ethylene glycol hexyl ether, diethylene glycol hexyl ether, diethylene glycol phenyl ether, ethylene glycol phenyl ether, and diethylene glycol n-butyl ether.

In one or more embodiments, the inkjet printer head may have a nozzle unit of the inkjet printer head adhesively coupled using an adhesive member including an epoxy resin.

In one or more embodiments, the epoxy resin may include one or more selected from among a bisphenol A epoxy resin, a bisphenol F epoxy resin, a phenolic novolac type (kind) epoxy resin, a cyclic aliphatic epoxy resin, an aliphatic polyglycidyl ether, a brominated epoxy, a rubber modified epoxy, and a glycidyl amine type (kind) epoxy.

In one or more embodiments, the solution for inkjet printer head may further include an additive, and the additive may include a surfactant and an antioxidant.

In one or more embodiments, the solution for inkjet printer head may be configured to remove a foreign substance from the nozzle unit of the inkjet printer head.

According to one or more embodiments, a method for cleaning an inkjet printer head including cleaning an inkjet printer head using a cleaning solution for an inkjet printer head is provided, the cleaning solution including a solvent; and a photocurable solute, the solvent having a non-affinity to an epoxy resin greater than a non-affinity to the photocurable resin.

In one or more embodiments, a method for cleaning an inkjet printer head may include: detaching an inkjet printer head and washing off ink remaining on the inkjet printer head; supplying the cleaning solution for the inkjet printer head to an ultrasonic washer; soaking a nozzle unit of the inkjet printer head in the ultrasonic washer; setting an ultrasonic frequency of the ultrasonic washer to vibrate the cleaning solution for an inkjet printer head and wash the nozzle unit of the inkjet printer head; and drying the washed nozzle unit of the inkjet printer head.

In one or more embodiments, in the detaching of an inkjet printer head and the washing off ink remaining on the inkjet printer head, a photocurable solute may be used to wash off ink remaining on the inkjet printer head, and the photocurable solute may include one or more selected from among 1,6-hexanediol diacrylate (HDDA), tripropylene glycol diacrylate (TPGDA), tricyclodecane dimethanol diacrylate (TCDDA), dipropylene glycol diacrylate (DPGDA), glycol diacrylate (GDA), neopentyl glycol diacrylate (NPGDA), ethylene glycol dimethacrylate (EGDMA), trimethylolpropane triacrylate (TMPTA), trimethylolpropane trimethacrylate (TMPTMA), pentaerythritol triacrylate (PETA), dimethylolpropane triacrylate (DMPA), and dipentaerythritol hexacrylate (DPHA).

In one or more embodiments, in the detaching of an inkjet printer head and the washing off ink remaining on the inkjet printer head, a washing pressure may be greater than or equal to 60 kPa and less than or equal to 80 kPa, and a washing time may be longer than or equal to 1 minute and shorter than or equal to 10 minutes.

In one or more embodiments, in the soaking of the nozzle unit of the inkjet printer head in the ultrasonic washer, the nozzle unit of the inkjet printer head may be soaked in an ultrasonic washer to a depth of 0.1 cm or more and 1 cm or less from the lowermost surface of the inkjet printer head.

In one or more embodiments, in the setting of an ultrasonic frequency of the ultrasonic washer to vibrate the cleaning solution for the inkjet printer head and to wash the nozzle unit of the inkjet printer head, an ultrasonic frequency of the ultrasonic washer may include a first frequency and a second frequency, the first frequency may be greater than or equal to 30 kHz and less than or equal to 50 kHz, and the second frequency may be greater than or equal to 90 kHz and less than or equal to 110 kHz. The cleaning solution may be vibrated to wash the nozzle unit.

In one or more embodiments, in the drying of the washed nozzle unit of the inkjet printer head, the washed nozzle unit of the inkjet head may be dried through air-blow under a condition of 70 kPa or more and 90 kPa or less for 1 to 5 minutes.

According to one or more embodiments, an electronic device manufactured by a manufacturing method for an electronic device is provided, the manufacturing method including washing an inkjet printer head using a cleaning solution for an inkjet printer head, the cleaning solution including a solvent and a photocurable solute, the solvent having a non-affinity to an epoxy resin greater than a non-affinity to the photocurable solute.

In one or more embodiments, the electronic device may include a display device; a processor configured to control the display device; a memory configured to store data for operation of the display device or the processor; and a power module configured to generate or supply power.

In one or more embodiments of the present disclosure, it becomes possible to provide a cleaning solution for an inkjet printer head may increase a lifespan of an inkjet printer head through an efficient washing of the inkjet printer head, a cleaning method for an inkjet printer head using the cleaning solution, and an electronic device manufactured using the cleaning method. The cleaning solution, characterized by its specific solvent and photocurable solute composition, should ensure that ink residues and other contaminants are effectively removed from the nozzle unit, thereby preventing or reducing clogging and mis-deposition of ink. This not only enhances the performance and reliability of the inkjet printer head but also reduces maintenance costs and downtime associated with frequent cleaning or replacement of the printer head. Additionally, the method for cleaning the inkjet printer head, which includes steps such as ultrasonic washing and/or controlled drying, further enhances the cleaning process, making it more efficient and less time-consuming. As a result, electronic devices manufactured utilizing this method exhibit improved quality and durability, contributing to overall better user satisfaction and reduced operational costs.

However, effects/aspects/embodiments of the present disclosure are not limited to the above but may be suitably expanded without departing from the spirit and scope of the present disclosure.

### BRIEF DESCRIPTION OF DRAWINGS

The accompanying drawings are included to provide a further understanding of the present disclosure and are incorporated in and constitute a part of this disclosure.
The drawings illustrate embodiments of the present disclosure and, together with the description, serve to explain principles of the disclosure. These and/or other features will become apparent and more readily appreciated from the following description of one or more embodiments, taken in conjunction with the accompanying drawings, in which:

FIG. 1A is a schematic illustration of a process for anticipation of a solubility of a material using a dispersion energy parameter δD, a polar-dipolar energy parameter δP, and a hydrogen bond energy parameter δH of Hansen parameters;

FIG. 1B is an illustration of a spatial coordinate of a dispersion energy parameter δD, a polar-dipolar energy parameter δP, and a hydrogen bond energy parameter δH of Hansen parameters of acetonitrile, DMF, ethanol, THF, and n-hexane;

FIG. 2A is an electron microscopy image of a bottom surface of a nozzle unit of an inkjet printer head before washing of the nozzle unit of the inkjet printer head with a cleaning solution for an inkjet printer head;

FIG. 2B is an electron microscopy image of a bottom surface of a nozzle unit of an inkjet printer head after washing of the nozzle unit of the inkjet printer head with a cleaning solution for an inkjet printer head;

FIG. 3 is a block diagram of an electronic device according to one or more embodiments; and

FIG. 4 are schematic diagrams of electronic devices according to one or more suitable embodiments.

### DETAILED DESCRIPTION

References will now be made in more detail to certain embodiments, of which examples are illustrated in the accompanying drawings, where like reference numerals refer to like elements throughout, and duplicative descriptions thereof may not be provided the disclosure, and duplicative descriptions thereof may not be provided for conciseness. The presented embodiments may have a variety of forms and permutations, but the present disclosure shall by no refers to be construed as being limited to the described embodiments. Rather, the present disclosure shall be construed to encompass all form, permutations, equivalents, and substitutes covered by the technical ideas and scope of the present disclosure. Accordingly, one or more embodiments are merely described, by referring to the drawings, to explain features of the present disclosure and to convey the scope of the disclosure to those skilled in the art.

Unless otherwise defined, all technical terms and scientific terms used herein have the same meaning as how they are generally understood by those of ordinary skill in the art to which the present disclosure pertains. However, if (e.g., when) the meanings do not match, a description, including a definition, of the present disclosure takes precedence.

Terms such as “first” and “second” may be used in describing one or more suitable elements, but the elements shall not be restricted to the terms. The terms may be used only to distinguish one element from the other. For instance, the first element may be named the second element, and vice versa, without departing the scope of the present disclosure. Unless clearly used otherwise, any expressions in a singular form may include a meaning of a plural form. For example, the singular forms “a,” “an,” “one,” and “the” are intended to include the plural forms as well, unless the context clearly indicates otherwise. The term “and/or” or “or” as used herein shall include the combination of a plurality of listed items or any of the plurality of listed items. Further, the utilization of “may” if (e.g., when) describing embodiments of the present disclosure refers to “one or more embodiments of the present disclosure”.

When an element (e.g., a region, a layer, a portion, and/or the like) is described to be “on,” “placed on,” “arranged on,” “connected to,” or “coupled to” another element, it shall be construed as being on, placed on, arranged on, connected to, or coupled to the other element directly but also as possibly having another element arranged between the element and the other element. In contrast, if (e.g., when) one element is described to be “directly on,” “directly arranged on,” “directly connected to,” or “directly coupled to” another element, it shall be construed that there is no other element arranged between the element and the another element.

An expression such as “comprise(s)/comprising”, “include(s)/including”, or “has (have)/having” is intended to designate a characteristic, a number, a step (e.g., act or task), an operation, an element, a part, and/or one or more (e.g., any suitable) combinations thereof, and shall not be construed to preclude any possibility of presence or addition of one or more other characteristics, numbers, steps, operations, elements, parts, and/or one or more (e.g., any suitable) combinations thereof.

Additionally, the terms “comprise(s)/comprising,” “include(s)/including,” “has (have)/having,” or other similar terms include or support the terms “consisting of” and “consisting essentially of,” indicating the presence of stated features, integers, steps, operations, elements, components, and/or groups, without or essentially without the presence of other features, integers, steps, operations, elements, components, and/or groups thereof.

When a component is described to be arranged “on (or below)” an element or “above (or below)” an element, it shall be construed not only as being arranged directly on (or below) the element but also as possibly having another element arranged between the component and the element.

In the present specification, “including A or B”, “A and/or B”, etc., represents A or B, or A and B.

As used herein, the term “and/or” includes any and all combinations of one or more of the associated listed items. Throughout the disclosure, the expression “at least one of a, b or c” indicates only a, only b, only c, both (e.g., simultaneously) a and b, both (e.g., simultaneously) a and c, both (e.g., simultaneously) b and c, all of a, b, and c, or variations thereof.

A size and a thickness of each configuration illustrated in a drawing is shown as an example for convenience, and embodiments of the present disclosure are not limited thereto.

References will now be made in more detail to certain embodiments, of which examples are illustrated in the accompanying drawings.

### Cleaning Solution for Inkjet Printer Head

A cleaning solution for inkjet printer head according to one or more embodiments of the present disclosure may include a solvent; and a photocurable solute, the solvent having (e.g., being characterized in having) a non-affinity to an epoxy resin greater than a non-affinity to the photocurable solute. According to the configuration, a lifespan of the inkjet printer head may be increased through efficient washing of the inkjet printer head, and adverse effects on the inkjet printer head may be minimized or reduced.

Although it is not limited thereto, the solvent may include one or more selected from among dipropylene glycol n-propyl ether, dipropylene glycol n-butyl ether, propylene glycol n-butyl ether, propylene glycol n-propyl ether, tripropylene glycol n-butyl ether, propylene glycol phenyl ether, dipropylene glycol phenyl ether, dipropylene glycol dimethyl ether, propylene glycol methyl ether acetate, dipropylene glycol methyl ether, dipropylene glycol methyl ether acetate, tripropylene glycol methyl ether, ethylene glycol hexyl ether, diethylene glycol hexyl ether, diethylene glycol phenyl ether, ethylene glycol phenyl ether, diethylene glycol n-butyl ether may be suitable to increase a lifespan of an inkjet printer head through efficient washing of the inkjet printer head, and tripropylene glycol methyl ether may be more suitable.

Although it is not limited thereto, the photocurable solute may include one or more selected from among 1,6-hexanediol diacrylate (HDDA), tripropylene glycol diacrylate (TPGDA), tricyclodecane dimethanol diacrylate (TCDDA), dipropylene glycol diacrylate (DPGDA), glycol diacrylate (GDA), neopentyl glycol diacrylate (NPGDA), ethylene glycol dimethacrylate, (EGDMA), trimethylolpropane triacrylate (TMPTA), trimethylolpropane trimethacrylate (TMPTMA), pentaerythritol triacrylate (PETA), dimethylolpropane triacrylate (DMPA), and dipentaerythritol hexacrylate (DPHA) may be suitable to increase solubility for ink remaining on the inkjet printer head and prevent or reduce formation of a clump caused by mixing with the remaining ink and contamination in the inkjet printer head for efficient washing off of remaining ink, and 1,6-hexanediol diacrylate (HDDA) may be more suitable.

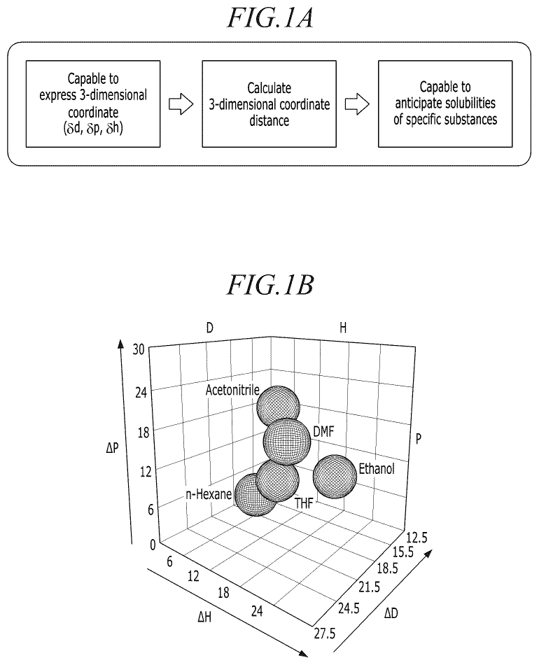

FIG. 1A is a schematic illustration of a process for anticipation of a solubility of a material using a dispersion energy parameter δD, a polar-dipolar energy parameter δP, and a hydrogen bond energy parameter δH of Hansen parameters. For example, FIG. 1A is a schematic illustration of a process for determining the solubility of a material utilizing a dispersion energy parameter δD, a polar-dipolar energy parameter δP, and a hydrogen bond energy parameter δH of Hansen parameters.

In order to determine solubility or miscibility between substances, similarity between the substances may be compared using intrinsic properties of a material. Solubility parameters, which quantitatively represent degrees of interaction within a substance among intrinsic properties affecting solubility or miscibility, may be used.

Each substance can dissolve or mix well with another substance that has similar solubility parameters. Among these solubility parameters, Hansen solubility parameter (HSP) suggested by Dr. C. Hansen in 1967 represents a suitable solubility property.

FIG. 1B is an illustration of a spatial coordinate of a dispersion energy parameter δD, a polar-dipolar energy parameter δP, and a hydrogen bond energy parameter δH of Hansen parameters of acetonitrile, DMF, ethanol, THF, and n-hexane.

According to FIG. 1B, δD, δP, and δH of Hansen parameters are shown in a 3-dimensional space, and close spatial coordinates of different substances indicate that the substances can dissolve or mix well with each other. For example, acetonitrile may have excellent or suitable solubility with DMF and low solubility with ethanol as illustrated by the close spatial coordinates of acetonitrile and DMF.

The Hansen solubility parameters (HSP, δ) may have a degree of bonding in a substance expressed with a relationship equation described herein.

Although it is not limited thereto, the solvent may have Hansen parameters of an epoxy resin and a photocurable solute satisfying conditions of the following Equation 1:

$$\sqrt{{( δ {p}_{1} - δ {p}_{2} )}^{2} + {( δ {h}_{1} - δ {h}_{2} )}^{2}} > \sqrt{{( δ {p}_{1} - δ {p}_{3} )}^{2} + {( δ {h}_{1} - δ {h}_{3} )}^{2}} \qquad Equation 1$$

In the equation, δp₁ may be a polar-dipolar energy parameter of a solvent, δh₁ may be a hydrogen bond energy parameter of a solvent, δp₂ may be a polar-dipolar energy parameter of an epoxy resin, δh₂ may be a hydrogen bond energy parameter of an epoxy resin, δp₃ may be a polar-dipolar energy parameter of a photocurable solute, and ohs may be a hydrogen bond energy parameter of a photocurable solute. Formula 1 shows that a non-affinity of an epoxy resin to a solvent is greater than a non-affinity of a photocurable solute to a solvent.

Although it is not limited thereto, the polar-dipolar energy parameter δp₁ of the solvent among the Hansen parameters greater than or equal to 1 and lower than or equal to 7 may be suitable to increase a lifespan of an inkjet printer head through efficient washing of the inkjet printer head due to non-affinity to an epoxy resin greater than a non-affinity to a photocurable solute, and the polar-dipolar energy parameter δp₁ greater than or equal to 1.7 and lower than or equal to 7 may be more suitable. That is, a suitable solvent may have a polar-dipolar energy parameter op greater than or equal to 1 and lower than or equal to 7. In one or more embodiments, a suitable solvent may have a polar-dipolar energy parameter δp₁ greater than or equal to 1.7 and lower than or equal to 7. For example, the polar-dipolar energy parameter δp₁ of the solvent among the Hansen parameters, ranging from 1 to 7, is suitable for increasing the lifespan of an inkjet printer head through efficient washing. A more suitable range for δp₁ is between 1.7 and 7.

Although it is not limited thereto, the hydrogen bond energy parameter δh₁ of the solvent among the Hansen parameters greater than or equal to 3.5 and lower than or equal to 15 may be suitable to increase a lifespan of an inkjet printer head through efficient washing of the inkjet printer head due to non-affinity to an epoxy resin greater than a non-affinity to a photocurable solute, and the hydrogen bond energy parameter δh₁ greater than or equal to 3.8 and lower than or equal to 14.3 may be more suitable. That is, a suitable solvent may have hydrogen bond energy parameter δh₁ greater than or equal to 3.5 and lower than or equal to 15. In one or more embodiments, a suitable solvent may have hydrogen bond energy parameter δh₁ greater than or equal to 3.8 and lower than or equal to 14.3. For example, the hydrogen bond energy parameter δh₁ of the solvent among the Hansen parameters, ranging from 3.5 to 15, is suitable for increasing the lifespan of an inkjet printer head through efficient washing. A more suitable range for δh₁ is between 3.8 and 14.3.

Although it is not limited thereto, the solvent having a non-affinity to a photocurable solute greater than or equal to 1.0 and lower than or equal to 7.5 may be suitable to increase a solubility of the photocurable solute for ink remaining on the inkjet printer head during washing of the inkjet printer head, and prevent or reduce formation of a clump caused by mixing with the remaining ink and contamination in the inkjet printer head for efficient washing off of remaining ink, and the non-affinity to a photocurable solute greater than or equal to 1.0 and lower than or equal to 6.9 may be more suitable. That is, a suitable solvent may have a non-affinity to a photocurable solute greater than or equal to 1.0 and lower than or equal to 7.5. In one or more embodiments, a suitable solvent may have a non-affinity to a photocurable solute greater than or equal to 1.0 and lower than or equal to 6.9. For example, the solvent having a non-affinity to a photocurable solute between 1.0 and 7.5 is suitable for increasing the solubility of the photocurable solute for ink remaining on the inkjet printer head during washing. This range helps prevent or reduce clump formation caused by mixing with remaining ink and contamination, ensuring efficient washing. A more suitable range for non-affinity to a photocurable solute is between 1.0 and 6.9.

Although it is not limited thereto, the solvent having a non-affinity to an epoxy resin greater than or equal to 5.0 and lower than or equal to 10.5 may minimize or reduce damage to an inkjet printer head in a process of washing the inkjet printer head adhesively coupled using an adhesive member including an epoxy resin and minimize or reduce contamination inside the inkjet printer head, and the non-affinity to epoxy resin greater than or equal to 5.2 and lower than or equal to 10.4 may be more suitable. That is, a suitable solvent may have a non-affinity to an epoxy resin greater than or equal to 5.0 and lower than or equal to 10.5. In one or more embodiments, a suitable solvent may have a non-affinity to a photocurable solute greater than or equal to 5.2 and lower than or equal to 10.4. For example, the solvent having a non-affinity to an epoxy resin between 5.0 and 10.5 is suitable for minimizing or reducing damage to an inkjet printer head during washing and reducing contamination inside the printer head. A more suitable range for non-affinity to epoxy resin is between 5.2 and 10.4.

Although it is not limited thereto, the solvent including one or more selected from among dipropylene glycol n-propyl ether, dipropylene glycol n-butyl ether, propylene glycol n-butyl ether, propylene glycol n-propyl ether, tripropylene glycol n-butyl ether, propylene glycol phenyl ether, dipropylene glycol phenyl ether, dipropylene glycol dimethyl ether, propylene glycol methyl ether acetate, dipropylene glycol methyl ether, dipropylene glycol methyl ether acetate, tripropylene glycol methyl ether, ethylene glycol hexyl ether, diethylene glycol hexyl ether, diethylene glycol phenyl ether, ethylene glycol phenyl ether, and diethylene glycol n-butyl ether may be suitable to increase a lifespan through efficient washing of an inkjet printer head due to a non-affinity to an epoxy resin greater than a non-affinity to a photocurable solute, and the solvent being tripropylene glycol methyl ether may be more suitable. That is, a suitable solvent may have a non-affinity to an epoxy resin greater than a non-affinity to a photocurable solute. In one or more embodiments, the solvent may include tripropylene glycol methyl.

According to one or more embodiments, the inkjet printer head, which contains the cleaning solution, may have a nozzle unit of the inkjet printer head adhesively coupled using an adhesive member including an epoxy resin.

Although it is not limited thereto, the epoxy resin may include one or more selected from among a bisphenol A epoxy resin, a bisphenol F epoxy resin, a phenolic novolac type (kind) epoxy resin, a cyclic aliphatic epoxy resin, an aliphatic polyglycidyl ether, a brominated epoxy, a rubber modified epoxy, and a glycidyl amine type (kind) epoxy.

Although it is not limited thereto, the bisphenol A epoxy resin may be at least one selected from among, for example, a liquid, such as YD128 (Kukdo Chemical), DER331 (Dow Chemical) and Epikote828 (hexion), and a solid, such as YD011, YD014, YD017 and YD019 (all from Kukdo Chemical), DER661, DER664, DER667 and DER669 (all from Dow Chemical), and Epon1001, Epon1004, Epon1007 and Epon1009 (all from Hexion).

Although it is not limited thereto, the bisphenol F epoxy resin may be at least one selected from among Epikote YL983-U (Japan Epoxy Co.), and RE-304, RE-404 and RE-303S (all from Nippon Kayaku).

Although it is not limited thereto, the cyclic aliphatic epoxy resin may be one or more selected from among 3,4-epoxycyclohexylmethyl-3,4-epoxycyclohexane carboxylate (ERL-4221), 2-(3,4-epoxy)cyclohexylmethyl-5,5′-spiro(3,4-epoxy)cyclohexane-m-dioxane (ERL-4234) and bis((4-methyl-7-oxabicyclo(4.1.0) hept-3-yl)methyl) adipate (ERL-4299).

Although it is not limited thereto, the aliphatic polyglycidyl ether may be one or more selected from among cyclohexanedimethanol diglycidyl ether, cyclohexanediol diglycidyl ether, neopentyl glycol diglycidyl ether, 1,6-hexanediol diglycidyl ether, trimethylolpropane triglycidyl ether, and polypropylene glycol diglycidyl ether.

Although it is not limited thereto, the cleaning solution for an inkjet printer head may further include an additive, and the additive may include a surfactant and/or an antioxidant.

Although it is not limited thereto, the surfactant may be one type (kind) and/or a (e.g., any suitable) mixture of two types (kinds).

A surfactant may have a high affinity to other components of a photocurable composition and increase an applicability of the cleaning solution for an inkjet printer head to implement excellent or suitable cleaning effects. Although it is not limited thereto, in order to increase an applicability of the cleaning solution for an inkjet printer head, a hydrophilic fluorine-based surfactant or a non-silicon surfactant may be used.

For example, the surfactant may be a polymeric or oligomeric fluorine-based surfactant. The surfactant may use a commercially available product and may be at least one selected from the group consisting of, for example, Glide 100, Glide110, Glide 130, Glide 460, Glide 440, Glide450 and/or RAD2500 from TEGO, Megaface F-251, F-281, F-552, F552, F-560, F-561, F-562, F-563, F-565, F-568, F-570 and/or F-571 from DIC (DaiNippon Ink & Chemicals), Surflon S-111, S-112, S-113, S-121, S-131, S-132, S-141 and/or S-145 from Asahi Glass, Fluorad FC-93, FC-95, FC-98, FC-129, FC-135, FC-170C, FC-430 and FC-4430 from Sumitomo 3M, Zonyl FS-300, FSN, FSN-100 and/or FSO from DuPont, and/or BYK-350, BYK-354, BYK-355, BYK-356, BYK-358N, BYK-359, BYK-361N, BYK-381, BYK-388, BYK-392, BYK-394, BYK-399, BYK-3440, BYK-3441, BYKETOL-AQ, and/or BYK-DYNWET 800 from BYK.

The antioxidant may react with unstable free radicals generated on a surface of a nozzle unit of an inkjet printer head to form an inert substance in a stable form through an oxidation reaction during washing of a nozzle unit of the inkjet printer head using a cleaning solution for an inkjet printer head. In addition, the antioxidant may be configured to suppress or reduce a chain reaction to prevent or reduce oxidation of the nozzle unit of the inkjet printer head.

Although it is not limited thereto, examples of the antioxidant may be butylated hydroxyl anisole (BHA), dibuthyl hydroxyl toluene (BHT), t-butyl hydroquinone (TBHQ), and these examples may be used alone or in combination of two or more.

According to one or more embodiments, the additive may include another element of a suitable additive, such as a leveling agent, a defoaming agent, a deodorizing agent, and/or a wetting agent.

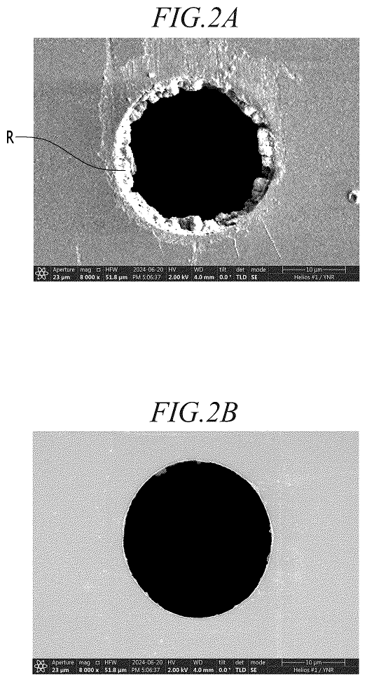

Although it is not limited thereto, the cleaning solution for an inkjet printer head may be used for removing a foreign substance R from the nozzle unit of the inkjet printer head. In a solution process based inkjet printer's utilization of an inkjet printer head and ink, it is difficult to avoid a phenomenon that a foreign substance R is attached to the nozzle unit of the inkjet printer head during a long-term use. Unless the foreign substance R attached to the nozzle unit of the inkjet printer head is removed, mis-deposition or unsuitable deposition during ejection of ink or non-ejection of ink may lead to reduction of a quality of a product. However, the cleaning solution for an inkjet printer head of the present disclosure may be configured to prevent or reduce reduction of a quality of a product by removing or completely removing a foreign substance from the nozzle unit of the inkjet printer head (see FIG. 2A and FIG. 2B).

### Cleaning Method for Inkjet Printer Head

According to one or more embodiments of the present disclosure, a cleaning method for an inkjet printer head may include a step (e.g., act or task) of washing an inkjet printer head using a cleaning solution for an inkjet printer head, the cleaning solution including a solvent and a photocurable solute, the solvent being characterized in having a non-affinity to an epoxy resin greater than a non-affinity to the photocurable solute. The cleaning solution for an inkjet printer head may increase a lifespan of the inkjet printer head through efficient washing of the inkjet printer head and may minimize or reduce adverse effects on the printer head.

A comparable cleaning method for an inkjet printer head may be disadvantageous in that it may be difficult to sufficiently remove contamination on a nozzle unit as the nozzle unit is washed merely by injection of inert gas and cleaning solution. According to the present disclosure, the problem of the comparable technique can be resolved.

According to one or more embodiments, a cleaning method for an inkjet printer head may include detaching an inkjet printer head and washing off ink remaining on the inkjet printer head; providing a cleaning solution for an inkjet printer head to an ultrasonic washer; soaking a nozzle unit of the inkjet printer head in an ultrasonic washer; setting an ultrasonic frequency of the ultrasonic washer to vibrate the cleaning solution for an inkjet printer head and wash the nozzle unit of the inkjet printer head; and drying the washed nozzle unit of the inkjet printer head.

Although it is not limited thereto, in the step (e.g., act or task) of detaching the inkjet printer head and washing off ink remaining on the inkjet printer head, a photocurable solute may be used to efficiently wash off ink remaining on the inkjet printer head.

Although it is not limited thereto, the photocurable solute, being one or more selected from among 1,6-hexanediol diacrylate (HDDA), tripropylene glycol diacrylate (TPGDA), tricyclodecane dimethanol diacrylate (TCDDA), dipropylene glycol diacrylate (DPGDA), glycol diacrylate (GDA), neopentyl glycol diacrylate (NPGDA), ethylene glycol dimethacrylate (EGDMA), trimethylolpropane triacrylate (TMPTA), trimethylolpropane trimethacrylate (TMPTMA), pentaerythritol triacrylate (PETA), dimethylolpropane triacrylate (DMPA), and dipentaerythritol hexacrylate (DPHA), may be suitable to increase solubility of ink remaining on the inkjet printer head and prevent or reduce formation of a clump caused by mixing with the remaining ink and contamination on the inkjet printer head for efficient washing off of remaining ink. In one or more embodiments, the photocurable solute may be 1,6-hexanediol diacrylate (HDDA).

Although it is not limited thereto, a washing pressure in the step (e.g., act or task) of detaching the inkjet printer head and washing off ink remaining on the inkjet printer head greater than or equal to 60 kPa and lower than or equal to 80 kPa, and a washing time longer than or equal to 1 minute and shorter than or equal to 10 minutes may be efficient for removing remaining ink on an inkjet printer head. A washing pressure in the step (e.g., act or task) of detaching the inkjet printer head and washing off ink remaining on the inkjet printer head greater than or equal to 65 kPa and lower than or equal to 75 kPa, and a washing time longer than or equal to 3 minutes and shorter than or equal to 7 minutes may be suitable to efficiently remove ink remaining on an inkjet printer head.

Ultrasonic washing uses acceleration and cavitation of a particle by ultrasound. Cavitation is a shock phenomenon that occurs if (e.g., when) a cavity collapses due to a change in a pressure generated ultrasound that is transmitted to a cleaning solution.

The lower an ultrasonic frequency is, the less a particle acceleration is and the stronger the impact force is. In addition, the lower an ultrasonic frequency is, the greater a size of a cavity is and the stronger the strength of cavitation is. Accordingly, in case of an ultrasonic frequency becoming lower, a large particle on a semiconductor substrate may be removed.

However, the higher an ultrasonic frequency is, the greater a particle acceleration is and the weaker the impact force is. In addition, the higher an ultrasonic frequency is, the smaller a size of cavity is and the weaker the strength of cavitation is. Accordingly, in case of an ultrasonic frequency becoming higher, capability to remove a large particle may be reduced. Nonetheless, a density of cavitation becomes greater, and penetration may be enhanced to allow precise washing.

Accordingly, ultrasonic energy may be provided to a cleaning solution to implement washing with ultrasonic vibration.

A comparable method for washing inside of a head and a nozzle unit using ultrasound and a circulation system may have an adverse effect on the nozzle unit by chemically reacting with an adhesive part upon exposure of a cleaning solution to the nozzle unit in a high-power ultrasonic environment in case that the nozzle unit and the head are adhesively connected. However, a solvent of a cleaning solution according to the present disclosure may resolve the problem because a non-affinity of the solvent to an epoxy resin adhesively coupling a nozzle unit and a head is relatively high.

Although it is not limited thereto, in the step (e.g., act or task) of soaking the nozzle unit of the inkjet printer head in the ultrasonic washer, upon providing the cleaning solution for an inkjet printer head to an ultrasonic washer, a temperature of the cleaning solution for an inkjet printer head greater than or equal to 50° C. and lower than or equal to 60° C. may be suitable to minimize or reduce damage to the nozzle unit of the inkjet printer head and efficiently wash the nozzle unit. In one or more embodiments, the temperature of the cleaning solution for an inkjet printer head may be greater than or equal to 53° C. and lower than or equal to 57° C.

Although it is not limited thereto, in the step (e.g., act or task) of soaking the nozzle unit of the inkjet printer head in the ultrasonic washer, soaking the nozzle unit of the inkjet printer head to a depth of greater than or equal to 0.1 cm and less than or equal to 1 cm from a lowermost surface of the inkjet printer head in an ultrasonic washer may be suitable for efficient washing as the nozzle unit of the inkjet printer head can be sufficiently immersed in the cleaning solution. In one or more embodiments, the depth may be greater than or equal to 0.3 cm and less than or equal to 0.7 cm from a bottom surface of the inkjet printer head. Spacing of greater than or equal to 1.5 cm from a bottom surface of an ultrasonic washer to avoid a contact of the nozzle unit of the inkjet printer head with the bottom surface of an ultrasonic washer may be suitable to minimize or reduce a damage to the nozzle unit of the inkjet printer head.

Although it is not limited thereto, in the step (e.g., act or task) of setting the ultrasonic frequency of the ultrasonic washer to vibrate the cleaning solution for the inkjet printer head and wash the nozzle unit of the inkjet printer head, an ultrasonic frequency of the ultrasonic washer may include a first frequency and a second frequency, and the first frequency greater than or equal to 30 kHz and less than or equal to 50 kHz and the second frequency greater than 90 kHz and less than or equal to 110 kHz may be suitable to remove a foreign substance on a nozzle unit of the inkjet printer head by washing the nozzle unit through vibrating the cleaning solution. In one or more embodiments, the first frequency may be greater than or equal to 35 kHz and less than or equal to 45 kHz and the second frequency may be greater than or equal to 95 kHz and less than or equal to 105 kHz. The first ultrasonic frequency and the second frequency may be variably controlled or selected depending on a particle size of ink remaining on the nozzle unit.

Although it is not limited thereto, in the step (e.g., act or task) of drying the washed nozzle unit of the inkjet printer head, drying the washed nozzle unit of the inkjet head by air-blowing with a pressure greater than or equal to 70 kPa and less than or equal to 90 kPa for longer than or equal to 1 minute and shorter than or equal to 5 minutes can minimize or reduce the damage to the nozzle unit of the inkjet printer head.

### Electronic Device Manufactured by Cleaning Method for Inkjet Printer Head Using Cleaning Solution for Inkjet Printer Head

According to one or more embodiments of the present disclosure, a display device may be manufactured by a manufacturing method for a display device, the manufacturing method including washing an inkjet printer head using a cleaning solution for an inkjet printer head, the cleaning solution for an inkjet printer head including a solvent and a photocurable solute, wherein the solvent is characterized in having a non-affinity to an epoxy resin greater than a non-affinity to a photocurable solute.

According to one or more embodiments of the present disclosure, an electronic device may be manufactured by a manufacturing method for an electronic device, the manufacturing method including washing an inkjet printer head using a cleaning solution for an inkjet printer head, the cleaning solution for inkjet printer head including a solvent and a photocurable solute, wherein the solvent has a non-affinity to an epoxy resin greater than a non-affinity to a photocurable solute.

A display device according to one or more embodiments of the present disclosure may be applicable to one or more suitable electronic devices. An electronic device according to one or more embodiments may include the described display device and further include a module or device having an additional function other than the display device.

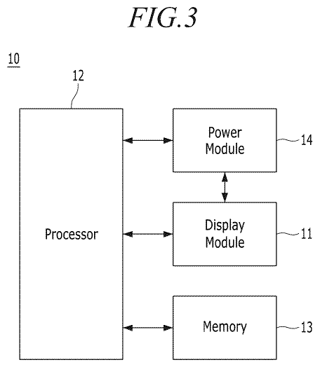

FIG. 3 is a block diagram of an electronic device according to one or more embodiments. Referring to FIG. 3, an electronic device 10 according to one or more embodiments may include a display device 11, a processor 12 configured to control the display device, a memory 13 configured to store data necessary for operation of the display device or the processor, and a power module 14 configured to generate or supply power.

The processor 12 may include at least one of a central processing unit (CPU), an application processor (AP), a graphic processing unit (GPU), a communication processor (CP), an image signal processor (ISP), or a controller.

The memory 15 may be configured to store data information necessary for operation of the processor 12 and the display device 11. In case that the processor 12 implements an application stored in the memory 15, an image data signal and/or an input control signal may be transferred to the display device 11, and the display device 11 may be configured to process the received signal and output an image information on a display screen.

The power module 14 may include a power supply module, such as a power adaptor and a battery device, and a power conversion module configured to convert power supplied by the power supply module and generate power for operation of the electronic device 10.

At least one of the elements of the described electronic device 10 may be included in an electronic device according to one or more embodiments described. In addition, some of individual modules functionally included in a single module may be included in an electronic device, and the other may be provided separately from the display device. For example, an electronic device may include a display device 11, and a processor 12, a memory 13, and a power module 14 may be provided in a form of another device within the electronic device 10 other than the electronic device.

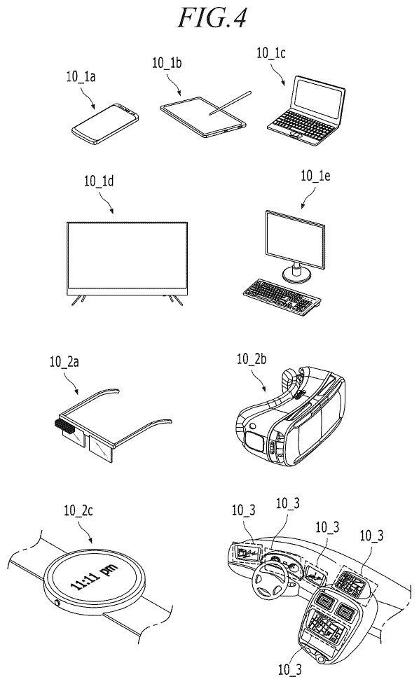

FIG. 4 are schematic diagrams of electronic devices according to one or more embodiments.

Referring to FIG. 4, one or more suitable electronic devices having display devices according to one or more embodiments may include not only an image displaying electronic device, such as a smart phone 10_1a, a tablet PC 10_1b, a laptop 10_1c, a TV 10_1d, and a desk monitor 10_1e, but also a wearable electronic device including a display module, such as smart glasses 10_2a, a head mounted display 10_2b, and a smart watch 10_2c, and a vehicle electronic device 10_3 including a display module, such as a dashboard of an automobile, center fascia, and CID (Center Information Display) and a room mirror display arranged on an instrument panel.

Hereinafter, embodiments and comparative examples of the present disclosure are described in more detail. A cleaning solution for an inkjet printer head, a method for cleaning an inkjet printer head using the cleaning solution, and an electronic device manufactured by the method will be specifically described in more detail. In addition, one or more embodiments are merely for comprehension of the present disclosure, and the scope of the present disclosure is not limited thereto.

### EXAMPLES

### Example 1. Manufacture of Cleaning Solution for Inkjet Printer Head

A mixture formed by dispersing and dissolving tripropylene glycol methyl ether, a surfactant, an antioxidant, and another random element is suitably stirred and mixed to manufacture a cleaning solution. The surfactant may be included in an amount of 3 wt % based on a total weight of the cleaning solution for an inkjet printer head. The antioxidant may be included in an amount of 1 wt % based on a total weight of the cleaning solution for an inkjet printer head. The stirring and mixing may be implemented by a sand mill, a homogenizer, a ball mill, a paint shaker, or an ultrasonic disperser. The stirring and mixing may also be implemented by a stirring device having a stirring blade, a magnetic stirrer, or a high-speed dispersion device.

### Example 2. Cleaning Method for Inkjet Printer Head Using Cleaning Solution for Inkjet Printer Head

An inkjet printer head contaminated by a foreign substance was detached, and ink remaining on the inkjet printer head was washed off with a photocurable solute, 1,6-Hexanediol diacrylate (HDDA). The ink remaining on the contaminated inkjet printer head includes the photocurable solute was mixed and washed off with the photocurable solute under a washing pressure of 70 kPa for 5 minutes.

The cleaning solution for an inkjet printer head manufactured in Example 1 was supplied to an ultrasonic washer.

A nozzle unit of the inkjet printer head was soaked to a depth of 0.5 cm from the lowermost surface of the inkjet printer head in the ultrasonic washer. The nozzle unit of the inkjet printer head was spaced and/or apart (e.g., spaced apart or separated) from a bottom surface of the ultrasonic washer by 1.5 cm or more to prevent or reduce contact of the nozzle unit of the inkjet printer head with the bottom surface of the ultrasonic washer.

An ultrasonic frequency of the ultrasonic washer was set to vibrate the cleaning solution for an inkjet printer head and wash the nozzle unit of the inkjet printer head. Upon washing the nozzle unit of the inkjet printer head using ultrasound, a temperature of the cleaning solution for an inkjet printer head was set to maintain a temperature of 55° C.

The ultrasonic frequency of the ultrasonic washer may include a first frequency and a second frequency. The first frequency was greater than or equal to 30 kHz and less than or equal to 50 kHz, and the second frequency was greater than or equal to 90 kHz and less than or equal to 110 kHz. By concurrently (e.g., simultaneously) applying the first frequency and the second frequency to the cleaning solution, ultrasonic vibration was applied to the nozzle unit of the inkjet printer head to allow efficient washing of the nozzle unit. A power of the ultrasonic washer was set to be 200 W.

The ultrasonic frequency of the ultrasonic washer was set to apply vibration to the cleaning solution for an inkjet printer head and implement washing of the nozzle unit of the inkjet printer head for 5 minutes, and after the washing, the washing stopped for 5 minutes. The process was repeated 3 times.

The washed nozzle unit of the inkjet printer head was dried by air-blowing under a pressure of 80 kPa for 3 minutes.

### Experimental Example

### Experimental Example 1. Analysis of Hansen Parameters and Non-Affinities of Cleaning Solution for Inkjet Printer Head

δd, δp, δh of Hansen parameters, non-affinities to a photocurable solute, and non-affinities to an epoxy resin of Examples 1 to 17 and comparative examples 1 to 4 are shown in Table 1.

δD, δP, δH of Hansen parameters are calculated values using a software of Hansen Solubility Parameter in Practice (HSPIP) developed by Dr. Hansen Group.

In Equation 1, polar-dipolar energy parameters of a solute, an epoxy resin, and a photocurable solute are applied to δp₁, δp₂, and ops, respectively, and hydrogen bond energy parameters of a solute, an epoxy resin, and a photocurable solute are applied to δh₁, δh₂, and δh₃, respectively.

δp₂ is a polar-dipolar energy parameter of an epoxy resin, and is 12.0. δh₂ is a hydrogen bond energy parameter of an epoxy resin, and is 9.0.

δp₃ is a polar-dipolar energy parameter of a photocurable solute, and is 3.1. δh₃ is a hydrogen energy parameter of a photocurable solute, and is 7.9.

$$\sqrt{{( δ {p}_{1} - δ {p}_{2} )}^{2} + {( δ {h}_{1} - δ {h}_{2} )}^{2}} > \sqrt{{( δ {p}_{1} - δ {p}_{3} )}^{2} + {( δ {h}_{1} - δ {h}_{3} )}^{2}} \qquad Equation 1$$

TABLE 1

| | | | | | Non- | Non- |
|---|---|---|---|---|---|---|
| | | | | | affinity to a | affinity to |
| | Compound | | | | photocurable | an epoxy |
| Example | name | δd | δp | δh | solute | resin |
| Example 1 | Dipropylene | 15 | 2.9 | 9.2 | 1.3 | 9.1 |
| | glycol | | | | | |
| | n-propyl | | | | | |
| | ether | | | | | |
| Example 2 | Dipropylene | 14.8 | 2.5 | 8.7 | 1.0 | 9.5 |
| | glycol | | | | | |
| | n-butyl | | | | | |
| | ether | | | | | |
| Example 3 | Propylene | 14.5 | 4.2 | 10.5 | 2.8 | 7.9 |
| | glycol n- | | | | | |
| | butyl ether | | | | | |
| Example 4 | Propylene | 15.3 | 4.9 | 11.2 | 3.8 | 7.4 |
| | glycol n- | | | | | |
| | propyl | | | | | |
| | ether | | | | | |
| Example 5 | Tripropylene | 14.8 | 1.7 | 7.9 | 1.4 | 10.4 |
| | glycol | | | | | |
| | n-butyl | | | | | |
| | ether | | | | | |
| Example 6 | Propylene | 17.4 | 5.3 | 11.5 | 4.2 | 7.2 |
| | glycol | | | | | |
| | phenyl | | | | | |
| | ether | | | | | |
| Example 7 | Dipropylene | 17.6 | 5.9 | 10.7 | 4.0 | 6.3 |
| | glycol | | | | | |
| | phenyl | | | | | |
| | ether | | | | | |
| Example 8 | Dipropylene | 14.9 | 2.1 | 3.8 | 4.2 | 11.2 |
| | glycol | | | | | |
| | dimethyl | | | | | |
| | ether | | | | | |
| Comparative | Propylene | 15.6 | 7.2 | 13.6 | 7.0 | 6.6 |
| Example 1 | glycol | | | | | |
| | methyl | | | | | |
| | ether | | | | | |
| Example 9 | Propylene | 15.6 | 5.6 | 9.8 | 3.1 | 6.4 |
| | glycol | | | | | |
| | methyl | | | | | |
| | ether | | | | | |
| | acetate | | | | | |
| Example | Dipropylene | 15.5 | 4 | 10.3 | 2.6 | 8.1 |
| 10 | glycol | | | | | |
| | methyl | | | | | |
| | ether | | | | | |
| Example | Dipropylene | 16.3 | 4.9 | 8 | 1.8 | 7.2 |
| 11 | glycol | | | | | |
| | methyl | | | | | |
| | ether | | | | | |
| | acetate | | | | | |
| Example | Tripropylene | 15.1 | 2.5 | 8.7 | 1.0 | 9.5 |
| 12 | glycol | | | | | |
| | methyl | | | | | |
| | ether | | | | | |
| Example | Ethylene | 16 | 6.9 | 10.9 | 4.8 | 5.4 |
| 13 | glycol | | | | | |
| | hexyl | | | | | |
| | ether | | | | | |
| Example | Diethylene | 16 | 6 | 10 | 3.6 | 6.1 |
| 14 | glycol | | | | | |
| | hexyl | | | | | |
| | ether | | | | | |
| Comparative | Ethylene | 16.1 | 8 | 13.1 | 7.1 | 5.7 |
| Example 2 | glycol | | | | | |
| | propyl | | | | | |
| | ether | | | | | |
| Example | Diethylene | 16.4 | 6.7 | 11.6 | 5.2 | 5.9 |
| 15 | glycol | | | | | |
| | phenyl | | | | | |
| | ether | | | | | |
| Example | Ethylene | 17.8 | 5.7 | 14.3 | 6.9 | 8.2 |
| 16 | glycol | | | | | |
| | phenyl | | | | | |
| | ether | | | | | |
| Comparative | Diethylene | 16.1 | 9.2 | 12.2 | 7.5 | 4.3 |
| Example 3 | glycol | | | | | |
| | ethyl ether | | | | | |
| Example | Diethylene | 16 | 7 | 10.6 | 4.7 | 5.2 |
| 17 | glycol n- | | | | | |
| | butyl ether | | | | | |
| Comparative | Ethylene | 16 | 7.6 | 12.3 | 6.3 | 5.5 |
| Example 4 | glycol n- | | | | | |
| | butyl ether | | | | | |

According to Table 1 above, Examples 1 to 17 have non-affinity to a photocurable solute smaller than a non-affinity to an epoxy resin, and their Hansen parameters satisfy Equation 1 above.

However, Comparative Examples 1 to 4 have non-affinity to a photocurable solute greater than a non-affinity to an epoxy resin, and their Hansen parameters do not satisfy Equation above. Therefore, Comparative Examples are not proper as a cleaning solution for an inkjet printer head.

### Experimental Example 2. Analysis of Foreign Substance on Nozzle Unit of Inkjet Printer Head

Electron microscopic photographs of a bottom surface of a nozzle unit of an inkjet printer head before and after washing the nozzle unit of the inkjet printer head with a cleaning solution for an inkjet printer head of Example 12 in Table 1 are shown in FIG. 2A and FIG. 2B.

According to FIG. 2A, a foreign substance R is present before washing the nozzle unit of the inkjet printer head with a cleaning solution for an inkjet printer head. However, according to FIG. 2B, a clean bottom surface with the foreign substance R removed after washing the nozzle unit of the inkjet printer head with the cleaning solution for an inkjet printer head is shown.

As utilized herein, the terms “substantially,” “about,” or similar terms are used as terms of approximation and not as terms of degree, and are intended to account for the inherent deviations in measured or calculated values that would be recognized by those of ordinary skill in the art. “About” as used herein, is inclusive of the stated value and refers to within an acceptable range of deviation for the particular value as determined by one of ordinary skill in the art, considering the measurement in question and the error associated with measurement of the particular quantity (i.e., the limitations of the measurement system). For example, “about” may refer to within one or more standard deviations, or within ±30%, 20%, 10%, or 5% of the stated value.

In the context of the present application and unless otherwise defined, the terms “use,” “using,” and “used” may be considered synonymous with the terms “utilize,” “utilizing,” and “utilized,” respectively.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this disclosure, including the claims, to expressly recite any sub-range subsumed within the ranges expressly recited herein.

The light emitting element, the display apparatus/device, the electronic apparatus, a device for manufacturing the same, or any other relevant apparatuses/devices or components according to one or more embodiments of the present disclosure described herein may be implemented utilizing any suitable hardware, firmware (e.g., an application-specific integrated circuit), software, and/or a (e.g., any suitable) combination of software, firmware, and hardware. For example, the one or more suitable components of the device may be formed on one integrated circuit (IC) chip or on separate IC chips. Further, the one or more suitable components of the device may be implemented on a flexible printed circuit film, a tape carrier package (TCP), a printed circuit board (PCB), or formed on one substrate. Further, the one or more suitable components of the device may be a process or thread, running on one or more processors, in one or more computing devices, executing computer program instructions and interacting with other system components for performing the one or more suitable functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of one or more suitable computing devices may be combined or integrated into a single computing device, or the functionality of a particular computing device may be distributed across one or more other computing devices without departing from the scope of one or more embodiments of the present disclosure.

The utilization of “may” when describing embodiments of the present disclosure refers to “one or more embodiments of the present disclosure.”

In the context of the present application and unless otherwise defined, the terms “use,” “using,” and “used” may be considered synonymous with the terms “utilize,” “utilizing,” and “utilized,” respectively.

In the present disclosure, each suitable feature of the one or more suitable embodiments of the disclosure may be combined or combined with each other, partially or entirely, and may be technically interlocked and operated in one or more suitable ways, and each embodiment may be implemented independently of each other or in conjunction with each other in any suitable manner unless otherwise stated or implied.

While certain embodiments of the present disclosure have been described in more detail above, anyone ordinarily skilled in the art to which the present disclosure pertains shall appreciate that there may be a variety of modifications and equivalent embodiments of the present disclosure without departing from the technical ideas and scopes of the present disclosure that are defined in the appended claims.

Therefore, a technical scope of the present disclosure shall not be limited by the detailed description of the specification, but shall be defined by the claims.

Although one or more embodiments of the present disclosure have been described in more detail above, the scope of the present disclosure is not limited thereto, and one or more suitable modifications and improvements made by those skilled in the art using the basic concepts of the present disclosure defined in the following claims and equivalents thereof also fall within the scope of the present disclosure.

What is claimed is:

1. A cleaning solution for an inkjet printer head comprising:
a solvent; and
a photocurable solute,
wherein the solvent has a non-affinity to an epoxy resin greater than a non-affinity to the photocurable solute.

2. The cleaning solution for an inkjet printer head of claim 1,
wherein the solvent has Hansen parameters of the epoxy resin and the photocurable solute satisfying Equation 1, and
$$\sqrt{{( δ {p}_{1} - δ {p}_{2} )}^{2} + {( δ {h}_{1} - δ {h}_{2} )}^{2}} > \sqrt{{( δ {p}_{1} - δ {p}_{3} )}^{2} + {( δ {h}_{1} - δ {h}_{3} )}^{2}} \qquad Equation 1$$
and
wherein in Equation 1:
δp₁ is a polar-dipolar energy parameter of the solvent,
δh₁ is a hydrogen bond energy parameter of the solvent,
δp₂ is a polar-dipolar energy parameter of the epoxy resin,
δh₂ is a hydrogen bond energy parameter of the epoxy resin,
δp₃ is a polar-dipolar energy parameter of the photocurable solute, and
δh₃ is a hydrogen bond energy parameter of the photocurable solute.

3. The cleaning solution for an inkjet printer head of claim 2,
wherein the polar-dipolar energy parameter δp₁ of the solvent among the Hansen parameters is greater than or equal to 1 and less than or equal to 7.

4. The cleaning solution for an inkjet printer head of claim 2,
wherein the hydrogen energy parameter δh₁ of the solvent among the Hansen parameters is greater than or equal to 3.5 and less than or equal to 15.

5. The cleaning solution for an inkjet printer head of claim 1,
wherein the solvent has a non-affinity to a photocurable solute greater than or equal to 1.0 and less than or equal to 7.5.

6. The cleaning solution for an inkjet printer head of claim 1,
wherein the solvent has a non-affinity to an epoxy resin greater than or equal to 5.0 and less than or equal to 10.5.

7. The cleaning solution for an inkjet printer head of claim 1,
wherein the solvent comprises at one or more selected from among dipropylene glycol n-propyl ether, dipropylene glycol n-butyl ether, propylene glycol n-butyl ether, propylene glycol n-propyl ether, tripropylene glycol n-butyl ether, propylene glycol phenyl ether, dipropylene glycol phenyl ether, dipropylene glycol dimethyl ether, propylene glycol methyl ether acetate, dipropylene glycol methyl ether, dipropylene glycol methyl ether acetate, tripropylene glycol methyl ether, ethylene glycol hexyl ether, diethylene glycol hexyl ether, diethylene glycol phenyl ether, ethylene glycol phenyl ether, and diethylene glycol n-butyl ether.

8. The cleaning solution for an inkjet printer head of claim 1,
wherein the inkjet printer head has a nozzle unit of the inkjet printer head adhesively coupled utilizing an adhesive member comprising an epoxy resin.

9. The cleaning solution for an inkjet printer head of claim 8,
wherein the epoxy resin comprises one or more selected from among a bisphenol A epoxy resin, a bisphenol F epoxy resin, a phenolic novolac type epoxy resin, a cyclic aliphatic epoxy resin, an aliphatic polyglycidyl ether, a brominated epoxy, a rubber modified epoxy, and a glycidyl amine type epoxy.

10. The cleaning solution for an inkjet printer head of claim 1, further comprising an additive,
wherein the additive comprises a surfactant and/or an antioxidant.

11. The cleaning solution for an inkjet printer head of claim 1,
wherein the cleaning solution for an inkjet printer head is configured to remove a foreign substance from a nozzle unit of the inkjet printer head.

12. A cleaning method comprising washing an inkjet printer head utilizing a cleaning solution for an inkjet printer head,
wherein the cleaning solution for an inkjet printer head comprises a solvent and a photocurable solute,
wherein the solvent has a non-affinity to an epoxy resin greater than a non-affinity to the photocurable solute, and
wherein the cleaning method is a cleaning method for an inkjet printer head.

13. The cleaning method of claim 12, the cleaning method comprising:
detaching an inkjet printer head and washing off ink remaining on the inkjet printer head;
supplying the cleaning solution for an inkjet printer head to an ultrasonic washer;
soaking a nozzle unit of the inkjet printer head in the ultrasonic washer;
setting an ultrasonic frequency of the ultrasonic washer to vibrate the cleaning solution for an inkjet printer head and wash the nozzle unit of the inkjet printer head; and
drying the washed nozzle unit of the inkjet printer head.

14. The cleaning method for an inkjet printer head of claim 13,
wherein in the detaching of the inkjet printer head and washing off ink remaining on the inkjet printer head, a photocurable solute is utilized to wash off ink remaining on the inkjet printer head, and
wherein the photocurable solute comprises one or more selected from among 1,6-hexanediol diacrylate (HDDA), tripropylene glycol diacrylate (TPGDA), tricyclodecane dimethanol diacrylate (TCDDA), dipropylene glycol diacrylate (DPGDA), glycol diacrylate (GDA), neopentyl glycol diacrylate (NPGDA), ethylene glycol dimethacrylate (EGDMA), trimethylolpropane triacrylate (TMPTA), trimethylolpropane trimethacrylate (TMPTMA), pentaerythritol triacrylate (PETA), dimethylolpropane triacrylate (DMPA), and dipentaerythritol hexacrylate (DPHA).

15. The cleaning method for an inkjet printer head of claim 13,
wherein in the detaching of the inkjet printer head and washing off ink remaining on the inkjet printer head, a washing pressure is greater than or equal to 60 kPa and less than or equal to 80 kPa, and a washing time is longer than or equal to 1 minute and shorter than or equal to 10 minutes.

16. The cleaning method for an inkjet printer head of claim 13,
wherein in the soaking of the nozzle unit of the inkjet printer head in the ultrasonic washer, the nozzle unit of the inkjet printer head is soaked in the ultrasonic washer to a depth of 0.1 cm or more and 1 cm or less from a lowermost surface of the inkjet printer head.

17. The cleaning method for an inkjet printer head of claim 13,
wherein in the setting of the ultrasonic frequency of the ultrasonic washer to vibrate the cleaning solution for the inkjet printer head and wash the nozzle unit of the inkjet printer head, an ultrasonic frequency of the ultrasonic washer comprises a first frequency and a second frequency,
wherein the first frequency is greater than or equal to 30 kHz and less than or equal to 50 kHz,
wherein the second frequency is greater than or equal to 90 kHz and less than or equal to 110 kHz, and
wherein the cleaning solution is vibrated to wash the nozzle unit.

18. The cleaning method for an inkjet printer head of claim 13,
wherein in the drying of the washed nozzle unit of the inkjet printer head, the washed nozzle unit of the inkjet printer head is dried through air-blow under a condition of 70 kPa or more and 90 kPa or less for 1 to 5 minutes.

19. An electronic device,
the electronic device being manufactured by a manufacturing method for an electronic device,
the manufacturing method comprising washing an inkjet printer head by utilizing a cleaning solution for an inkjet printer head,
wherein the cleaning solution for an inkjet printer head comprises a solvent and a photocurable solute, and
wherein the photocurable solute has a non-affinity to an epoxy resin greater than a non-affinity to the photocurable solute.

20. The electronic device of claim 19,
wherein the electronic device comprises a display device; a processor configured to control the display device; a memory configured to store data necessary for operation of the display device or the processor; and a power module configured to generate or supply power.
